(19) United States
(12) Patent Application Publication
(10) Pub. No.: US 2006/0132385 A1
(43) Pub. Date: Jun. 22, 2006

(54) Optically addressable matrix display

(76) Inventors: Marcellinus Petrus Carolus Michael Krijn, Eindhoven (NL); Franciscus Paulus Maria Budzelaar, Eindhoven (NL); Jurgen Jean Louis Hoppenbrouwers, Eindhoven (NL); Maurizio Majani, Eindhoven (NL); Johannes Josephus Wilhelmus Maria Rosink, Eindhoven (NL); Bart Andre Salters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/545,059

(22) PCT Filed: Feb. 2, 2004
(86) PCT No.: PCT/IB04/50068

§ 371 Date: Aug. 10, 2005

(30) Foreign Application Priority Data
Feb. 13, 2003 (EP) 03100325.4

(51) Int. Cl. G09G 3/10

(52) U.S. Cl. 345/42

(57) ABSTRACT

A matrix display device comprises a matrix of optically addressable pixels (Pij). The pixels (Pij) comprise a light sensitive element (LSij) and a pixel light generating element (LGij). The light generating element (LGij) of a particular pixel (Pij) produces light with a brightness which depends on the state of the light sensitive element (LSij). The state of the light sensitive element (LSij) depends on an amount of light impinging on it. The matrix display further comprises a laser (LAS) which generates laser beam (LB), and a laser scanner (SCA) which scans the laser beam (LB) along the pixels (Pij). At the instant the laser beam (LB) impinges on the light sensitive element (LSij), the brightness of the laser beam (LB) determines the state of the light sensitive element (LSij), and thus the state of the pixel light generating element (LGij).

The invention relates to an active matrix display and a display apparatus comprising a matrix display.

U.S. Pat. No. 6,215,462 discloses a matrix display device with a plurality of rows of pixels. The rows of the matrix display are selected one by one. Each row is associated with a light waveguide which transports light generated by a first light emission element to the pixels of the row. A particular row is selected if the associated select light emission element produces light; all the other rows are not selected because their associated select light emission elements do not produce light.

Each pixel comprises a series arrangement of a light sensitive element and a pixel light emission element. A data voltage in accordance with the image data to be displayed is supplied to the series arrangement via column conductors. In the selected row of pixels, the light generated by the select light emission element associated with the selected row reaches the pixels of the selected row via the associated light waveguide. Consequently, the light sensitive elements of the pixels of the selected row have a low impedance, and the data voltage occurs substantially over the pixel light emission elements of the pixels of the selected row. Thus, the selected row of pixels will generate an amount of light in accordance with the image data presented on the column conductors which each are connected to a column of pixels. In the rows which are not selected, the select light emission elements do not produce light, and thus the impedance of the light sensitive elements of not selected pixels is high. For these pixels, the data voltage will substantially occur across the high impedance of the light sensitive elements, and consequently, the voltage across the pixel light emission elements will be below a threshold value such that the pixel light emission elements will not produce light.

Thus, each pixel of a particular row will be addressed during a single row select period and will only produce light in accordance with the data voltage during this single row select period. After all the other rows have been selected, the pixels of the particular row again will produce light in accordance with the data voltages during a single row select period.

It is an object of the invention to provide a matrix display which has a simpler construction.

A first aspect of the invention provides a matrix display as claimed in claim 1. A second aspect of the invention provides a display apparatus as claimed in claim 18. Advantageous embodiments are defined in the dependent claims.

The matrix display device in accordance with the first aspect of the invention comprises a matrix of optically addressable pixels. The pixels each comprise a light sensitive element and a pixel light generating element. The pixel light generating element of a particular pixel produces light (further also referred to as pixel light) with a brightness which depends on the state of the light sensitive element of the particular pixel. The state of the light sensitive element depends on the amount of light impinging on it. The matrix display further comprises a laser which generates a laser beam, and a laser scanner which scans the laser beam along the pixels.

At the instant the laser beam impinges on the light sensitive element of the particular pixel, the light produced by the laser determines the state of the light sensitive element, and thus the state of the pixel light generating element. It has to be noted that the actual light generated by the pixels substantially originates from the pixel light generating elements and not from the laser. Preferably, the laser is a simple laser such as diode laser of which the brightness requirements are relatively low because only the state of the light sensitive elements needs to be changed.

The use of the laser which scans along the pixels has the advantage that both the light waveguides and the multiple light sources supplying the light to be transported by the light waveguides are not required. Consequently, the use of the laser provides a less complicated optically addressable matrix display.

In an embodiment in accordance with the invention as claimed in claim 2, the brightness of the laser beam produced by the laser is modulated in accordance with input data. This has the advantage that only a single laser has to be driven with the data signal and it is not required to provide a plurality of different data signals to a plurality of lines of the pixels. This simplifies the data driver. Alternatively, it is possible to use more than one laser, each laser scans a corresponding sub-area of the pixels, but still, the number of lasers will be considerable less than the number of lines of pixels. The lines of pixels may be rows or columns of the matrix display.

In an embodiment in accordance with the invention as claimed in claim 3, all the pixels are in a state in which the laser light is able to change the state of the pixels. This construction has the advantage that it is possible to address the pixels although a same drive voltage is supplied to all the pixels. Only the pixel(s) on which the laser beam impinges will adapt its (their) state in accordance with the light produced by the laser, the other pixels will not be influenced. It is not required to select a single row of pixels such that only the pixels of this selected row are sensitive to the laser beam, while all other pixels have to be non-selected. The row driver is not required at all because all the pixels may receive the same voltage. Again the construction of the optically addressable matrix display is simplified. This drive method is in particular interesting if the spot dimensions of the laser are sufficiently small to cover substantially a single pixel only.

In contrast, in the optically addressable matrix display disclosed in U.S. Pat. No. 6,215,462, the data signals are supplied to a complete column of pixels. The light waveguides are required to prevent changing the state of the pixels which are not in the selected row.

In an embodiment in accordance with the invention as claimed in claim 4, the drive voltage is supplied to the pixels via drive electrodes which are connected to all the pixels. This simplifies the construction of the matrix display. If more than one laser is used, the drive electrodes interconnect the pixels of each sub-area if the lasers are operated in parallel.

In an embodiment in accordance with the invention as claimed in claim 5, the laser can be of a simple construction as only two states are required, the linearity of the transfer characteristic of the laser is not important. Grayscales can be produced with the well known subfield drive wherein a field comprises several subfields and the brightness of a pixel depends on in which of these subfields this pixel is addressed to supply light.

In an embodiment in accordance with the invention as claimed in claim 7, the drive voltage is supplied across the series arrangement of the pixel light generating element and an impedance element of which the impedance depends on the state of the light sensitive element. If the drive voltage has a sufficiently high level and the impedance of the impedance element is low, the pixel light generating element will generate light because the drive voltage is substantially present across it. If the drive voltage has a sufficiently high level and the impedance of the impedance element is high, the pixel light generating element will not generate light because the select voltage is substantially present across the light sensitive element.

In an embodiment in accordance with the invention as claimed in claim 8, the light sensitive element itself is arranged in series with the pixel light generating element. This has the advantage that a minimal amount of elements is used in a pixel, which provides a simple matrix display. The impedance of the light sensitive element is low with respect to the impedance of the pixel light generating element if the laser light impinges on it, and the impedance of the light sensitive element is high with respect to the impedance of the pixel light generating element when no laser light impinges on it.

In an embodiment in accordance with the invention as claimed in claim 9, the pixels comprise a capacitor to obtain a memory behavior of the pixels. The memory behavior of the pixels increases the brightness of the pixels as the state of the pixels will be held after the laser light does not anymore impinge on them.

In an embodiment in accordance with the invention as claimed in claim 10, the pixels are constructed such that in a pixel a portion of the pixel light generated by the pixel light generating element reaches the associated light sensitive element of the pixel. The light sensitive element is sensitive to the pixel light to obtain an optical feedback of the portion of the pixel light to the light sensitive element.

This feedback may be used to obtain a memory behavior of the pixel or to influence the memory behavior of the pixel. With respect to the prior art U.S. Pat. No. 6,215,462, the memory behavior of the pixel will cause the pixel which is switched on during a select period to stay on after the select period. The pixel will generate light during substantially the whole frame period and not during the select period only, and consequently the brightness will increase.

This feedback may also be used to influence an intrinsic memory behavior of a pixel caused by a capacitance of the pixel. The portion of the light impinging on the light sensitive element is used to discharge the capacitance, as is defined in the embodiment of the invention of claim 13.

In an embodiment in accordance with the invention defined in claim 11, the light sensitive element itself is arranged in series with the pixel light generating element. This has the advantage that the construction of the matrix display is simple.

In an embodiment in accordance with the invention defined in claim 12, a switching element has a main current path arranged in series with the pixel light generating element and a control electrode coupled to the light sensitive element. This has the advantage that the impedance of the light sensitive element is less important. If laser light impinges on the light sensitive element its impedance changes, which impedance change causes the switching element to get a low impedance. The portion of the light of the pixel light generating element which impinges on the light sensitive element causes the impedance of the switching element to stay low. Thus, again a memory behavior of the pixel is obtained.

In an embodiment in accordance with the invention defined in claim 13, the laser directs its laser beam towards the further light sensitive element. A short light pulse from the laser suffices to charge the capacitor via the further switching element. The capacitor is discharged by the light sensitive element which receives a portion of the pixel light from the pixel light generating element.

In this manner, the behavior a phosphor of a cathode ray tube is imitated: in response to the light pulse provided by the scanning laser, the pixel starts with a high brightness which gradually decreases. The value of the capacitor determines the time during which the brightness decreases to zero. The brightness of the laser beam, and/or the duration the laser beam is present at a particular pixel determine the peak brightness of the pixel. Further, it is an advantage that the brightness of the pixel is substantially independent on the quality of the pixel light generating element if this is a (Poly) LED (light emitting diode). If the (poly) LED does not function well, it well take longer to discharge the capacitor, and thus, the net amount of light produced is substantially equal.

Thus, now the intrinsic memory behavior of the pixels is influenced by the feedback of the portion of the light generated by the pixel light generating element which impinges on the light sensitive element In an embodiment in accordance with the invention defined in claim 14, the pixels of the matrix display are selected or addressed line by line by supplying appropriate select voltages to the lines of pixels. For not selected lines, the select voltage has a level which does not allow the state of the light generating element to be changed, independent on whether light impinges on the light sensitive element or not. For a selected line, the select voltage has a level which does allow the state of the light generating element to change dependent on whether light impinges on the light sensitive element or not.

In accordance with the image to be displayed, the input data controls the laser to supply light to the pixels of the selected line which should produce light, and no light to the pixels of the selected line which should not produce light, or the other way around, depending on the construction of the pixels.

Because only the selected line of pixels is sensitive to the light generated by the laser, and the non-selected lines of pixels are not sensitive to the light generated by the laser, the optical state of the non-selected lines of pixels is unaltered. The spot of the laser may, in the direction substantially perpendicular to the selected line of pixels cover more than a single pixel. Only the selected pixel will, if required, change state.

In contrast in the optical addressable display in accordance with the prior art U.S. Pat. No. 6,215,462, the light which impinges on the light sensitive elements of the pixels selects a line of pixels by making the impedance of the light sensitive element low such that the data voltage is substantially present across the light generating element. For a non selected line of pixels, no light impinges on the light sensitive elements which then have a relatively large impedance with respect to the light generating elements. Thus, substantially no voltage occurs across the light generating elements and consequently, not selected lines of pixels can not produce light. This has the drawback that each pixel of a particular row will be addressed during a single row select period only and thus will only produce light in accordance with the data voltage during this single row select period only. After all the other rows have been selected, the pixels of the particular row again will produce light in accordance with the data voltages during a single row select period only.

In the optical addressable matrix display in accordance with the invention, non-selected lines of pixels produce an amount of light determined during the select period of these lines. The brightness of the pixels will be higher because the duration of the period the pixels are producing light is much longer than a single select period.

If a row of pixels is selected by a select voltage which has a sufficient high voltage allowing the state of the pixels to be changed by the laser light, the impedance of the light sensitive element will be low with respect to the impedance of the pixel light generating element if laser light is received, and the impedance of the light sensitive element will be relatively high if no laser light is received. If the impedance of the light sensitive element is low, the select voltage supplied across the series arrangement of the light sensitive element and the pixel light generating element will substantially occur across the pixel light generating element. The pixel light generating element will generate pixel light of which a portion is received by the light sensitive element. As this portion of the light is sufficient to keep the impedance of the light sensitive element low, a memory behavior of the pixel is obtained. Thus, once the pixel light generating element produces light, the state of the light sensitive element will be kept in this state even when no laser light is received anymore.

This lowers the constraints put on the levels of the select voltage. The select voltage still has to be large enough during a select period to enable the laser light to change the optical state of the selected pixels, and the select voltage has to be low enough for not selected pixels such that the optical state of the non-selected pixels will not change with the laser light. It is not anymore required that the select voltage for non-selected pixels has to be high enough to keep the optical state of these pixels substantially unaltered. The memory behavior of the pixels will take care of this last constraint.

In an embodiment in accordance with the invention defined in claim 15, the laser supplies a substantially fixed intensity of the laser beam. The drive voltage is varied while the laser beam scans along the pixels. It is possible to supply the same drive voltage to all the pixels. This may have the disadvantage that the total capacitance of the pixels has to be charged or discharged at a high speed. If the exact position of the laser beam is known in at least one direction, it is also possible to vary the drive voltage for a line of pixels only.

In an embodiment in accordance with the invention defined in claim 16, the laser scanner comprises a mirror which deflects the laser beam along the pixels. Although it is possible to move the laser itself such that the laser beam scans along the pixels, it is more reliable and easier to use the mirror. If the laser is moved, the wires supplying a voltage across the laser may interrupt due to the continuous movement of the laser. The wires may hamper a fast and precise movement of the laser.

In an embodiment in accordance with the invention defined in claim 17, the scanning of the laser beam is synchronized with the input data to obtain the correct position of the image on the display screen. This is in particular important if the display is a color display with different pixels producing light with different colors. For example, in a full color display, a red, green and blue pixel form a complete pixel. The data has to be supplied synchronized with the position of the laser beam on the display to ensure that the data supplied belongs to the color of the pixel on which the laser beam impinges.

These and other aspects of the invention are apparent from and will be elucidated with reference to the embodiments described hereinafter.

In the drawings:

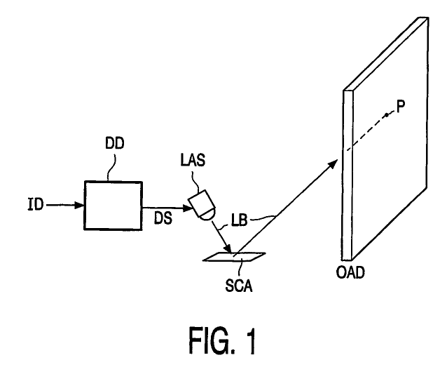

FIG. 1 shows a schematic representation of a display apparatus in accordance with the invention wherein the display cells are addressed with a laser,

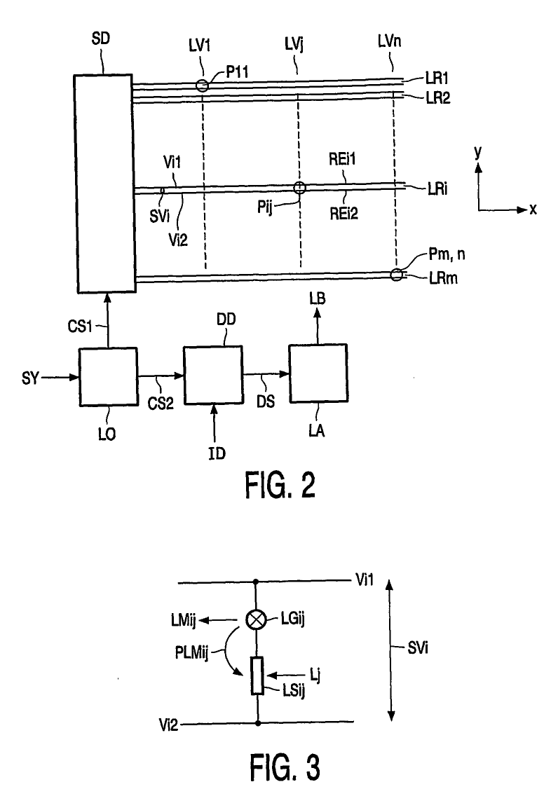

FIG. 2 shows an embodiment of a matrix display apparatus with laser addressed display cells,

FIG. 3 shows an embodiment of a display cell in accordance with the invention,

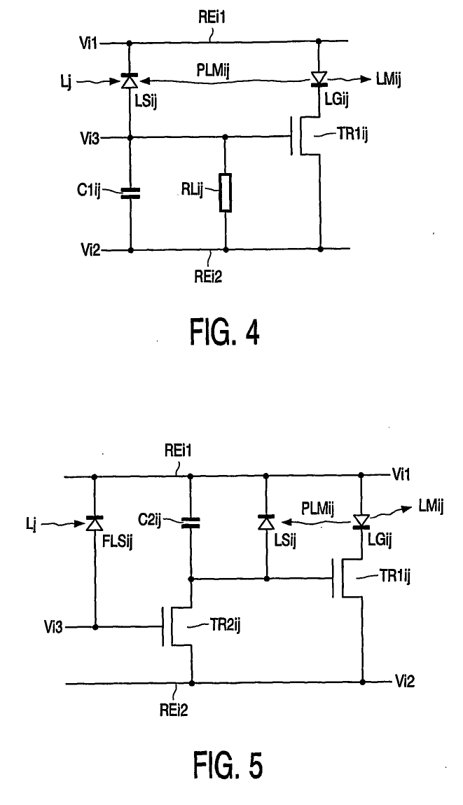

FIG. 4 shows another embodiment of a display cell in accordance with the invention,

FIG. 5 shows another embodiment of a display cell in accordance with the invention, and

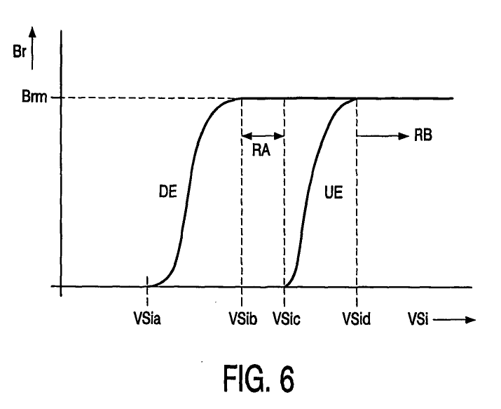

FIG. 6 shows suitable levels of the select voltage.

The same references in different Figs. refer to the same signals or to the same elements performing the same function.

FIG. 1 shows a schematic representation of a display apparatus in accordance with the invention wherein the display cells (also referred to as pixels) are addressed with a laser. The optical addressable display device OAD comprises a matrix of pixels Pij (see FIG. 2). A laser LAS generates a laser beam LB which impinges on the light sensitive elements LSij of FIG. 3 or the light sensitive elements FLSij of FIG. 5. The scanning of the laser beam LB can be controlled with an x/y scanner SCA. This x/y scanner is mechanically moveable to scan the laser beam LB along the light sensitive elements LSij or FLSij of the display OAD. Preferably, the laser beam LB scans along the rows of the pixels Pij one by one. It is also possible to use more than one laser LAS to scan along the pixels Pij. The laser scanner SCA receives synchronization information belonging to the video signal to be displayed to coordinate the position of the laser with the timing of the video signal.

The laser scanning simplifies the construction of the display because the light-guides and the multiple select light sources are not required. Further, the data driver becomes less complex as a single drive signal for a single laser has to be generated instead of the large amount of drive signals, one for each select light source.

In an embodiment in accordance with the invention, a data driver DD modulates the light produced by the laser LAS in accordance with input data ID. This has the advantage that only the laser LAS has to be driven with a data signal DS and it is not required to provide a large plurality of different data signals to a plurality of lines of the pixels Pij. This simplifies the data driver DD considerably. It is possible to use more than one laser LAS, each laser LAS scans a corresponding sub-area of the pixels Pij, but still, the number of lasers LAS will be considerable less than the number of lines of pixels Pij. The lines of pixels Pij are rows or columns of the optically addressable matrix display OAD.

FIG. 2 shows an embodiment of a matrix display apparatus with optically addressed display cells or pixels.

The matrix display comprises a matrix of pixels Pij (P1 to Pmn) which are associated with intersections of imaginary columns LVj (LV1 to LVn) and sets of two row electrodes REi1, REi2. The index i indicates the row number, the index j indicates the column number of the matrix display. The row electrodes REi1 and REi2 extend in the x-direction, the columns LVj extend in the y-direction. In a transposed matrix display, the x and y direction are interchanged.

A pixel driver SD supplies first row voltages Vi1 to the first row electrodes REi1 and second row voltages Vi2 to the second row electrodes REi2. The drive voltage SVi occurs between the first row electrode REi1 and the second row electrode REi2 of the i^{th} row.

A data driver DD receives input data ID to be displayed and supplies a data signal DS to the laser circuit LA which comprises the laser LAS and the laser scanner SCA. The intensity of the laser beam LB depends on the input data ID.

A control circuit CO receives synchronization information SY to supply a control signal CS1 to the pixel driver SD to select the rows LRi of pixels Pij one by one, and a control signal CS2 to the data driver DD to supply the data signal DS to the laser circuit LA such that the scanning of the laser LAS is synchronized with the data signal DS.

The pixels Pij of the matrix display are selected or addressed row by row by supplying appropriate pixel voltages SVi to the rows LRi of pixels Pij. For not selected rows LRi, the pixel voltage SVi has a level which does not allow the state of the light generating elements LGij to be changed, independent on whether the light of the laser beam LB impinges on the light sensitive elements LSij or not. Preferably, the level of the pixel voltage SVi should be selected to substantially preserve the state of the light generating elements LGij obtained during a last select period. For a selected row LRi, the pixel voltage SVi has a level which does allow the state of the light generating elements LGij to change dependent on whether the light of the laser beam LB impinges on the light sensitive elements LSij or not.

In accordance with the image to be displayed, the input data ID controls the laser LAS to supply light to the pixels Pij of the selected row LRi which should produce light, and no light to the pixels Pij of the selected row LRi which should not produce light, or the other way around depending on the construction of the pixels Pij.

Because the selected row LRi of pixels Pij is sensitive to the light generated by the laser LAS, and the non-selected rows LRi of pixels Pij are not sensitive to the light generated by the laser LAS, the non-selected lines LRi of pixels Pij preserve their optical state. Consequently, it is possible to change the optical state of the pixels Pij of a selected row LRi in accordance with the input data ID to be displayed while the optical state of these pixels Pij is unaltered during the time the other rows LRi are selected.

The laser LAS may generate a plurality of different brightness levels to control a plurality of brightness level of the pixel light generating elements. Preferably the laser LAS is only used to address the pixels Pij and not to generate gray scales. Consequently, a simple diode laser LAS suffices because a well defined transfer characteristic is not required.

In another embodiment in accordance with the invention, the spot of the laser LAS is sufficiently small to cover substantially a single pixel Pij only. All the pixels Pij are in a state in which the laser beam LB is able to change the state of the pixels Pij. In this manner, it is possible to address the pixels Pij one by one although a same drive voltage VSi is supplied to all the pixels Pij. Only the pixel Pij on which the laser beam LB impinges will adapt its state in accordance with the light produced by the laser LAS, the other pixels Pij will not be influenced. It is not required to select a single row of pixels Pij such that only the pixels Pij of this selected row are sensitive to the laser beam LB, while all other pixels Pij have to be non-selected. The row driver SD is not required at all because all the pixels may receive the same voltage SVi. Both all the row electrodes RE1 and all the row electrodes RE2 can be interconnected, and a single pixel voltage SVi can be applied between these two groups of interconnected row electrodes RE1, RE2. Such an optically addressable matrix display OAD has a simple construction and thus can be produced easy and cheap. The display OAD may even be a foil. The row electrodes may become electrode plates which usually are positioned at opposite sides of the substrate of the optically addressable matrix display OAD which comprises the pixels Pij.

The laser LAS may scan the rear or the front of the optically addressable matrix display OAD. Rear projection has the advantage that it is easy to prevent ambient light to reach the light sensitive elements LSij or FLSij. In a front projector, a filter layer in the optically addressable matrix display OAD has to cover the light sensitive elements LSij or FLSij such that the ambient light is sufficiently blocked and does not influence the state of the pixels Pij, while the laser beam LB is able to sufficiently pass the filter to be able to control the state of the pixels Pij.

In a color display, the position of the laser beam LB on the display screen of the optically addressable matrix display OAD needs to be known to synchronize the intensity of the laser beam LB corresponding to the video information ID with the position of the Red, Green and Blue pixels Pij of the optically addressable matrix display OAD. The position of the laser beam LB on the display screen may be determined with separate light sensitive elements. It is also possible to detect the position of the laser beam LB on the screen with the already available light sensitive elements LSij of the pixels Pij. Extra electrodes may be required to be able to detect the state of the light sensitive elements LSij.

FIG. 3 shows an embodiment of a display cell in accordance with the invention. The display cell or pixel Pij comprise a series arrangement of a pixel light generating element LGij and a light sensitive element LSij of which an impedance depends on a brightness of light received. The series arrangement of the pixel light generating element LGij and the light sensitive element LSij is arranged between the first row electrode REi1 and the second row electrode REi2 to receive the pixel voltage SVi. The voltage on the first row electrode is denoted by Vi1, the voltage on the second row electrode RE2 is denoted by Vi2, the pixel voltage SVi is the difference of the voltages Vi1 and Vi2.

If the intensity of the laser beam LB is modulated and the same pixel voltage SVi is supplied to all the pixels Pij, the state of the pixel light generating elements LGij is determined by the intensity of the laser beam LB. The level of the pixel voltage SVi is selected sufficiently high to allow the state of the pixel light generating elements LGij to be changed dependent on whether the intensity of the laser beam LB is high or low. In this embodiment in accordance with the invention, the pixels Pij are constructed such that the pixel light generating elements LGij produce light when the impedance of the light sensitive elements LSij is low, and the pixel light generating elements LGij do substantially not produce light when the impedance of the light sensitive elements LSij is high. Thus, a high intensity of the laser beam LB will cause the pixel light generating element LGij to produce light and a low intensity of the laser beam LB will cause the pixel light generating element LGij to not produce light.

If the spot size of the laser beam LB is larger than one pixel, or the alignment of the laser beam LB with the pixels Pij is not optimal, it may still be required to select a row LRi of pixels Pij which are sensitive to the intensity of the laser beam LB while the pixels Pij of the non-selected rows LRi are insensitive to the intensity of the laser beam LB. The pixel voltage SVi supplied to the selected row LRi should be sufficiently high to allow the state of the pixel light generating element LGij to change in accordance with the intensity of the laser beam LB. If the laser beam LB has a high intensity, the laser light which impinges on the light sensitive element LSij, will cause its impedance to become low with respect to the impedance of the light generating element LGij and thus the select voltage will substantially occur across the light generating element LGij. The pixel Pij will generate light. If no (or a sufficient low brightness of the) laser light impinges on the light sensitive element LSij, its impedance will be high with respect to the impedance of the light generating element LGij, and the pixel voltage SVi occurs substantially across the light sensitive element LSij. The pixel Pij will not generate light.

For non-selected rows LRi, the pixel voltage SVi has a suitable low voltage the intensity of the laser beam LB has no influence of the state of the pixels Pij. Due to the low level of the select voltage SVi, a pixel Pij which was off (not producing light) will not be able to start producing light, and a pixel Pij which was on (producing light) will not be able to stop producing light. Preferably, the level of the select voltage SVi should however be sufficient high to prevent all pixels Pij to switch off. Suitable levels of the select voltage SVi are elucidated with respect to FIG. 6.

Many constructions of the pixels Pij are possible, for example, it is also possible to use a pixel construction as shown in FIG. 4 wherein the light sensitive element LSij is used to switch a transistor TR1ij of which the main current path is arranged in series with the pixel light generating element LGij. Any other construction of the pixels Pij wherein an impedance value of an element arranged in series with the pixel light generating element LGij depends on whether laser light is supplied to the pixel will operate in the same manner.

In an embodiment in accordance with the invention with optical feedback, a portion of the pixel light PLMij produced by the pixel light generating element LGij will reach the light sensitive element LSij.

The operation of the pixel Pij is shown in FIG. 3 is elucidated in the now following. The total amount of light falling onto the light sensitive element LSij is the combination of the portion of the pixel light PLMij generated by the pixel light generating element LGij and the laser beam LB.

Initially, the pixel Pij is in the off state, even if a considerable pixel voltage SVi is present across the series arrangement. The high impedance of the light sensitive element LSij causes the pixel voltage SVi to be substantially present over the light sensitive element LSij, and thus a substantially zero voltage is present across the pixel light generating element LGij.

If a particular pixel Pij should produce light, the laser LAS will emit light which reaches the light sensitive element LSij. The impedance of the light sensitive element LSij will become low with respect to the impedance of the pixel light generating element LGij and the pixel voltage SVi will be substantially present across the pixel light generating element LGij. The pixel light generating element LGij will start to emit the pixel light LMij. Upon switching off the laser light (which usually is when, due to the scanning, the laser beam leaves the pixel Pij), the pixel Pij remains in the on-state since the portion of the light PLMij generated by the pixel light generating element LGij is captured by the light sensitive element LSij which keeps it impedance low. The pixel Pij may be switched off by reducing the select voltage SVi below a threshold value. The pixel Pij thus has an in-built memory brought about by optical feedback to the light sensitive element LSij.

If a particular pixel Pij should not produce light when the laser beam LB impinges on it, the intensity of the laser beam should be low such that the impedance of the light sensitive element LSij will stay high.

To drive a complete matrix display with a video signal, all the pixels Pij have to be addressed during a field period to provide a field of input video data ID during this field period to the pixels Pij. The next field of input data ID is supplied to the pixels Pij during the next field period. During a field period, the rows LRi of the matrix display are selected one by one while the laser beam LB scans over the selected row LRi. Before writing data to the pixels Pij first all pixels Pij have to be reset to produce no light. This is possible by reducing the select voltage SVi below a threshold value for all the rows LRi. Then, a particular row LRi is selected during a row select period by supplying a select voltage SVi to this row which is sufficiently high. At the same time the laser scans along the pixels Pij of the selected row LRi. Next, at the end of the row select period, the select voltage SVi is lowered to a value that is sufficient to sustain the pixels Pij within this row, but that is too low to readdress the pixels Pij. Thus the select voltage SVi in not selected rows is too low to allow the laser beam LB to alter the state of the pixels Pij but not so low that the pixels Pij are reset.

Alternatively, if all the pixels Pij receive the same pixel voltage VSi, the addressing is inherently with the scanning of the laser beam LB along the pixels Pij.

If more grey scales are required it is possible to use the well known sub-field drive method. Each subfield of the field period can be addressed in the same manner as elucidated above for a field period.

The pixel light generating elements LGij may, for example, comprise small lasers, LED's (light emitting diodes), OLED's, PolyLED's, small incandescent lamps or fluorescent lamps, or light generating elements as used in plasma displays. The light sensitive elements may, for example, comprise LDR's (light dependent resistors), or LAS (light activated thyristors or other light activated electronic switches).

Such an optical addressed display is inexpensive and relatively easy to manufacture compared to an LCD. The dimensions are easily scalable, only simple two terminal memory elements are required, and a high lumen efficacy is possible.

FIG. 4 shows another embodiment of a display cell in accordance with the invention. The pixel light generating element LGij is arranged in series with the main current path of a transistor TR1ij between the first row electrode RE1i and the second row electrode RE2i. The voltage on the first row electrode RE1i is denoted by Vi1, the voltage on the second row electrode RE2i is denoted by Vi2, the pixel voltage SVi is the difference of the voltages Vi1 and Vi2. The light sensitive element LSij is arranged between the control electrode of the transistor TR1ij and the first row electrode RE1i. An optional capacitor C1ij is arranged between the control electrode of the transistor TR1ij and the second row electrode RE2i. An optional leakage resistor RLij is also arranged between the control electrode of the transistor TR1ij and the second row electrode RE2i.

If laser light with a sufficient high brightness impinges on the light sensitive element LSij, the transistor TR1ij becomes low-ohmic and the data voltage VSi is substantially present across the pixel light generating element LGij which starts emitting pixel light LMij. A portion of the pixel light PLMij impinges on the light sensitive element LSij which thus will keep the pixel in the on-state even when the laser light is not anymore supplied. The pixel light generating element LGij will stop emitting light when the select voltage SVi drops below a particular value. The pixel light generating element LGij can also be switched off (or on) with the voltage Vi3.

The optional capacitor C1ij buffers the voltage on the control electrode of the transistor TR1ij and provides a memory behavior. The optional resistor RLij discharges the capacitor and thus determines the time constant of the memory.

FIG. 5 shows another embodiment of a display cell in accordance with the invention. The pixel light generating element LGij is arranged in series with the main current path of a transistor TR1ij between the row electrode RE1i and the row electrode RE2i. The voltage on the row electrode RE1i is denoted by Vi1, the voltage on the row electrode RE2i is denoted by Vi2, the pixel voltage SVi is the difference of the voltages Vi1 and Vi2. The light sensitive element LSij is arranged between the control electrode of the transistor TR1ij and the row electrode RE1i. An optional capacitor C2ij is arranged between the control electrode of the transistor TR1ij and the row electrode RE1i. A main current path of a transistor TR2ij is arranged between the control electrode of the transistor TR1ij and the second row electrode RE2i. A light sensitive element FLSij is arranged between the control electrode of the transistor TR2ij and the row electrode RE1i.

If a short light pulse impinges on the light sensitive element FLSij, the transistor TR2ij becomes low-ohmic and the capacitor C2ij is charged to the select voltage VSi. The transistor TR1ij starts conducting and the pixel light generating element LGij starts emitting pixel light LMij. The charge on the capacitor C2ij will keep the transistor TR1ij conductive. A portion of the pixel light PLMij impinges on the light sensitive element LSij which will discharge the capacitor C2ij. The impedance of the transistor TR1ij will gradually increase. In this manner, the behavior a phosphor of a cathode ray tube is imitated: in response to the light pulse which occurs when the laser beam LB scans along the pixel Pij, the pixel Pij starts with a high brightness which gradually decreases. The value of the capacitor C2ij determines the time during which the brightness decreases to zero. The brightness and/or duration of the light pulse determine the peak brightness of the pixel Pij.

Further, it is an advantage that the brightness of the pixel Pij is substantially independent on the quality of the pixel light generating element if this is a (Poly) LED (light emitting diode). If the (poly) LED does not function well, it well take longer to discharge the capacitor C2ij, and thus, the net amount of light produced is substantially equal.

It possible to switch off (or on) the pixel Pij with the voltage Vi3 at the control electrode of the transistor TR2ij.

FIG. 6 shows suitable levels of the select voltage. The select voltage VSi is set out along the horizontal axis and the brightness Br of a pixel Pij is set out along the vertical axis. If the pixel Pij is off at a low value of the select voltage VSi (VSi<VSia) and thus the brightness Br is very low or zero, and the select voltage VSi is increased, the pixel Pij will start emit light according to the curve UE. Thus above the value VSic, the pixel Pij starts emitting light and the maximum brightness Brm is available for select voltages above the value VSid. When successively, the select voltage VSi is decreased the brightness of the pixel will follow the curve DE. Thus the brightness starts decreasing at the level VSib and is low below the level VSia. Due to the hysteretic behavior of the pixel Pij, three areas are available. The pixel brightness Br is low below the level VSia, thus the pixels Pij can be switched off by lowering the select voltage VSi below the level VSia. Within the area RA, pixels Pij which where on (have the high brightness level Brm) will stay on and pixels which are off (have the low brightness level) will stay off. Within the area RB, the select voltage SVi is sufficiently large to switch a pixel Pij on when light impinges on the pixel Pij.

In a practical embodiment the levels are approximately: VSib=4 Volts, VSic=5 Volts, and VSid=7 Volts. These levels are indications only and may differ for different displays and different configurations of the pixels Pij.

It should be noted that the above-mentioned embodiments illustrate rather than limit the invention, and that those skilled in the art will be able to design many alternative embodiments without departing from the scope of the appended claims.

For example, the transistors which are shown to be MOSFETS, may also be bipolar transistors. All the transistors may be of the opposite conductivity type, the circuits have to be adapted in a manner known to the skilled person.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A matrix display device with a matrix of optically addressable pixels (Pij), the pixels (Pij) comprising a light sensitive element (LSij) having a state depending on a brightness of control light (Lj) impinging on it, and a pixel light generating element (LGij) for generating pixel light (LMij) with a brightness depending on the state of the light sensitive element (LSij),
the matrix display device comprising:
a laser (LAS) for generating a laser beam (LB), and
a laser scanner (SCA) for scanning the laser beam (LB) along the pixels (Pij) to supply the control light (Lj).

2. A matrix display device as claimed in claim 1, wherein the matrix display further comprises a laser driver (DD) for intensity modulating the laser beam (LB) in accordance with input data (ID).

3. A matrix display device as claimed in claim 2, wherein the matrix display further comprises a pixel driver (SD) for supplying a substantial same drive voltage (SVi) to the pixels (Pij).

4. A matrix display device as claimed in claim 3, wherein the matrix display further comprises drive electrodes (RE1, RE2) for supplying the drive voltage (SVi) to the pixels (Pij), the drive electrodes (RE1, RE2) interconnecting the pixels (Pij).

5. A matrix display device as claimed in claim 1, wherein the laser driver (DD) is adapted for modulating the laser beam (LB) to have two brightness levels only.

6. A matrix display device as claimed in claim 1, wherein the light sensitive element (LSij) is a light-dependent resistor or a light-activated switch.

7. A matrix display device as claimed in claim 1, wherein the pixel light generating element (LGij) and an impedance element (LSij; TR1ij) are arranged in series, a value of an impedance of the impedance element (LSij; TR1ij) being dependent on the state of the light sensitive element (LSij), and wherein the matrix display further comprises a pixel driver (SD) for supplying a drive voltage (SVi) to the series arrangement of the impedance element (LSij; TR1ij) and the pixel light generating element (LGij).

8. A matrix display device as claimed in claim 7, wherein the impedance element (LSij; TR1ij) comprises the light sensitive element (LSij) of the pixel (Pij).

9. A matrix display device as claimed in claim 1, wherein the pixels (Pij) comprise a capacitance (C2ij) to obtain a memory behavior.

10. A matrix display device as claimed in claim 1, wherein the light sensitive element (LSij) and the pixel light generating element (LGij) are positioned with respect to each other for obtaining an optical feedback of a portion of the pixel light (PLMij) from the pixel light generating element (LGij) to the light sensitive element (LSij).

11. A matrix display device as claimed in claim 10, wherein the light sensitive element (LSij) and the pixel light generating element (LGij) of the pixel (Pij) are arranged in series, and wherein the portion of the pixel light (PLMij) is sufficient for keeping an impedance of the light sensitive element (LSij) relatively low with respect to an impedance of the pixel light generating element (LGij).

12. A matrix display device as claimed in claim 10, wherein the pixels (Pij) further comprise a switching element (TR1ij) having a main current path arranged in series with the pixel light generating element (LGij), said series arrangement being coupled to the pixel driver (SD) for receiving the associated one of the select voltages (SVi), and having a control electrode coupled to the light sensitive element (LSij), and wherein the portion of the pixel light (PLMij) is sufficient for obtaining an impedance of the switching element (TR1ij) being relatively low with respect to an impedance of the pixel light generating element (LGij).

13. A matrix display device as claimed in claim 12, wherein the pixels (Pij) further comprise:
a capacitor (C2ij) coupled to the control electrode of the first mentioned switching element (TR1ij),
a further light sensitive element (FLSij) for receiving the data light (Lj), and
a further switching element (TR2ij) having a control electrode coupled to the further light sensitive element (FLSij) and a main current path coupled to the control electrode of the first mentioned switching element (TR1ij).

14. A matrix display device as claimed in claim 1, wherein the matrix display further comprises a pixel driver (SD) for supplying drive voltages (SVi) to lines (LRi) of the pixels (Pij), the drive voltages (SVi) having a level which does not allow the amount of pixel light (LMij) of the pixel light generating elements (LGij) to be substantially changed for not selected lines (LRi) of the pixels (Pij), the drive voltages (SVi) having a level which does allow the amount of pixel light (LMij) of the pixel light generating elements (LGij) to be changed for a selected one of the lines (LRi) of pixels (Pij).

15. A matrix display device as claimed in claim 1, wherein the matrix display further comprises:
drive electrodes (RE1, RE2) for supplying a drive voltage (SVi) to the pixels (Pij), the drive electrodes (RE1, RE2) interconnecting the pixels (Pij) in a same line (LRi), the drive voltage (SVi) determining the state of the pixel light generating element (LGij) when the laser beam (LB) impinges on the light sensitive element (LSij) of the pixel (Pij), and
a laser driver (DD) for generating a substantially fixed intensity of the laser beam (LB).

16. A matrix display device as claimed in claim 1, wherein the laser scanner (SCA) comprises a mirror for deflecting the laser beam (LB) to scan along the pixels (Pij).

17. A matrix display device as claimed in claim 1, wherein the matrix display further comprises a synchronizing circuit (CO) for synchronizing a position (P) where the laser beam (LB) impinges on the pixels (Pij) and an instant of occurrence of the input data (ID).

18. A display apparatus comprising a matrix display as claimed in claim 1.
